(19) United States
(12) Patent Application Publication
(10) Pub. No.: US 2025/0222477 A1
(43) Pub. Date: Jul. 10, 2025

(54) PUSH-BUTTON SHOWER HEAD CONFIGURED TO BE PAUSED AT ANY TIME

(71) Applicant: RUNNER (XIAMEN) CORP., Xiamen (CN)

(72) Inventors: Bifu DAI, Xiamen (CN); Xinzhan HU, Xiamen (CN)

(73) Assignee: RUNNER (XIAMEN) CORP., Xiamen (CN)

(21) Appl. No.: 18/964,740

(22) Filed: Dec. 2, 2024

(30) Foreign Application Priority Data
Jan. 9, 2024 (CN) 202420051709.3

(51) Int. Cl. B05B 12/00; B05B 1/18

(52) U.S. Cl. CPC B05B 12/0026; B05B 1/18

(57) ABSTRACT

A push-button shower head configured to be paused at any time includes a body, where a movable core shaft is provided in the body; a water passing channel is formed in the core shaft; a pause mechanism configured to control whether to allow water to pass through the water passing channel is provided on the core shaft; the body is further provided with at least two water outlet channels; a water distribution mechanism is further provided in the body; and a water inlet end of the water distribution mechanism is configured to communicate with the water passing channel, and a water outlet end of the water distribution mechanism is configured to communicate with the water outlet channel. The push-button shower head can be paused at any time for water from different water outlet channels, thereby switching off the water flow, and providing a better experience feeling for the user.

### CROSS REFERENCE TO THE RELATED APPLICATIONS

This application is based upon and claims priority to Chinese Patent Application No. 202420051709.3, filed on Jan. 9, 2024, the entire contents of which are incorporated herein by reference.

### TECHNICAL FIELD

The present disclosure relates to a push-button shower head configured to be paused at any time.

### BACKGROUND

Shower heads can be seen everywhere in our lives. They are mainly used to take a shower. Existing shower heads have many functions. However, when realizing a certain function, a shower head cannot be paused directly or cannot supply a small amount of water. For example, when shampoo, body wash and the like are used by a user, the shower head is paused only after switching several sprays. This is inconvenient in operation, and it is not possible to pause and switch the sprays naturally.

### SUMMARY

To solve the above technical problem, an objective of the present disclosure is to provide a push-button shower head configured to be paused at any time.

The present disclosure is achieved by the following technical solutions:

A push-button shower head configured to be paused at any time includes a body, where a movable core shaft is provided in the body; a water passing channel is formed in the core shaft; a pause mechanism configured to control whether to allow water to pass through the water passing channel is provided on the core shaft; the body is further provided with at least two water outlet channels; a water distribution mechanism is further provided in the body; and a water inlet end of the water distribution mechanism is configured to communicate with the water passing channel, and a water outlet end of the water distribution mechanism is configured to communicate with the water outlet channel.

In an embodiment of the present disclosure, the water distribution mechanism includes a water distributor configured to rotate relative to the body; and a water outlet end of the water distributor can communicate with the water outlet channel.

In an embodiment of the present disclosure, a water inlet cavity is formed in the water distributor; a cup seal and a spring cooperating with each other are provided between the water outlet end of the water distributor and a water inlet end of the water outlet channel; and through rotation of the water distributor, the water distributor can communicate with different water outlet channels.

In an embodiment of the present disclosure, the push-button shower head configured to be paused at any time further includes a water inlet body; a water inlet end of the water inlet body is configured to communicate with the water passing channel, and a water outlet end of the water inlet body is configured to communicate with the water inlet cavity; the water distributor can rotate relative to the water inlet cavity; and the water inlet body can be fixed on the body.

In an embodiment of the present disclosure, the push-button shower head configured to be paused at any time further includes an adapter connected to the water inlet body; the core shaft can be sleeved in the adapter; a water outlet end of the water passing channel can communicate with the adapter; a branched water channel is further provided on the adapter; and a water inlet end of the branched water channel is configured to communicate with the water passing channel, and a water outlet end of the branched water channel is configured to communicate with the water inlet cavity through the water inlet body.

In an embodiment of the present disclosure, the core shaft is further connected to a push rod; the push rod can move synchronously with the core shaft; a rack is provided on the push rod; a connecting gear is provided on a circumferential sidewall of the water distributor; the rack can be cooperatively connected to the connecting gear; and the core shaft moves to drive the water distributor to rotate relative to the body.

In an embodiment of the present disclosure, the push-button shower head configured to be paused at any time further includes a push button; the push button can be connected to a central shaft of the pause mechanism; the push button can be configured to push the core shaft to move relative to the body; and the push button is configured to drive the pause mechanism to control whether to allow water to pass through the water passing channel.

In an embodiment of the present disclosure, the pause mechanism includes a rotatable rotor; the rotor is provided in a water passing cavity in the water passing channel; a baffle is provided on a sidewall of the rotor; and the baffle can be cooperatively connected to an inlet and/or an outlet of the water passing cavity.

In an embodiment of the present disclosure, a guide strip is further provided on the body, and the guide strip can cooperate with the push rod.

The push-button shower head configured to be paused at any time provided by the present disclosure has the following beneficial effects: With the push button, the present disclosure can be paused conveniently at any time, thereby providing a better experience feeling for the user. Meanwhile, with the only one push button that can be pushed and pressed, the present disclosure can be switched in the water channel and paused. Therefore, the present disclosure meets the ergonomic design, with the fewer parts and the lower cost.

### BRIEF DESCRIPTION OF THE DRAWINGS

To describe the technical solutions in the present disclosure more clearly, the following briefly introduces the drawings required for describing the embodiments or the prior art. Apparently, the drawings in the following description show merely some embodiments of the present disclosure, and a person of ordinary skill in the art may still derive other drawings from these drawings without creative efforts.

FIG. 1 is a sectional view according to the present disclosure;

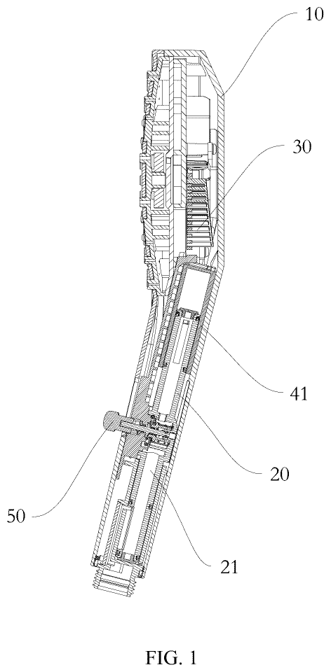

FIG. 2 is a first schematic view according to the present disclosure;

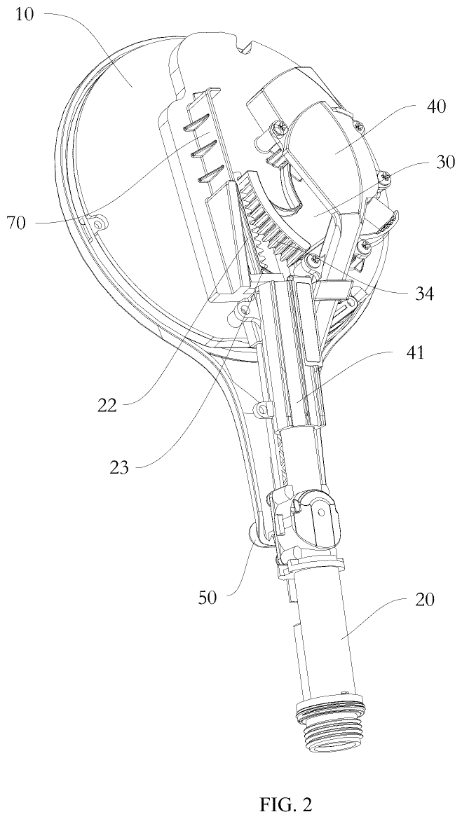

FIG. 3 is a second schematic view according to the present disclosure;

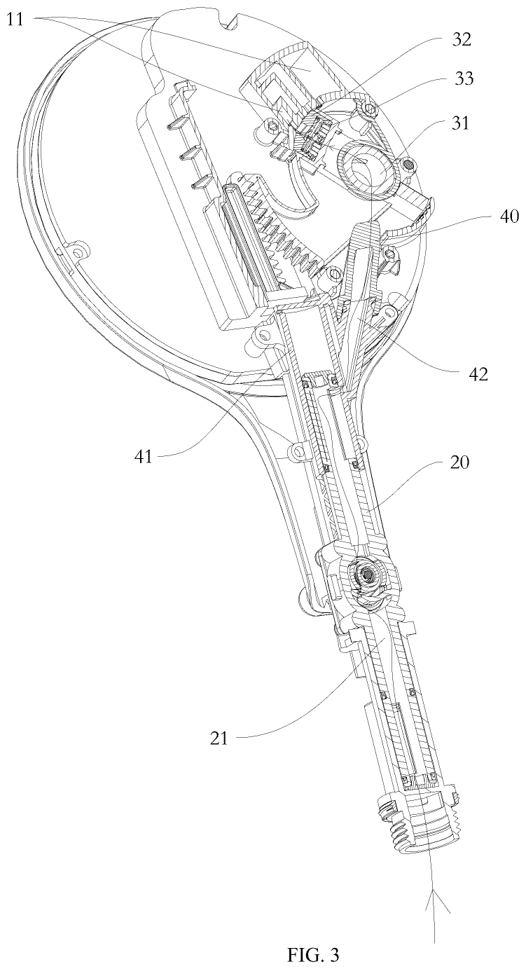

FIG. 4 is a partially schematic view when a water passing channel allows water to pass through according to the present disclosure;

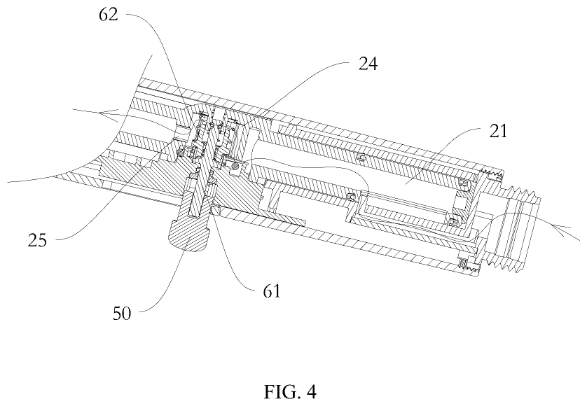

FIG. 5 is a partially schematic view when a water passing channel does not allow water to pass through according to the present disclosure; and

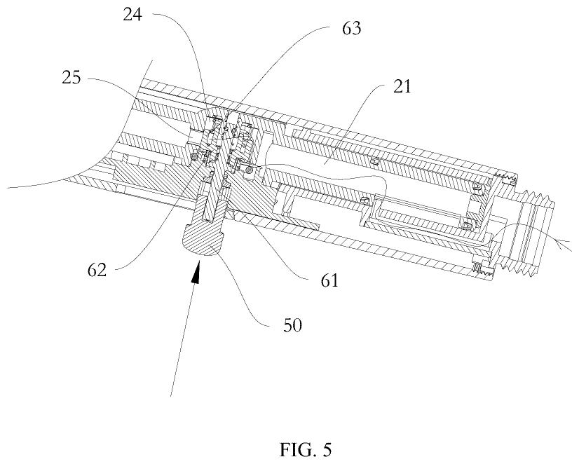

FIG. 6 is a partially exploded view according to the present disclosure.

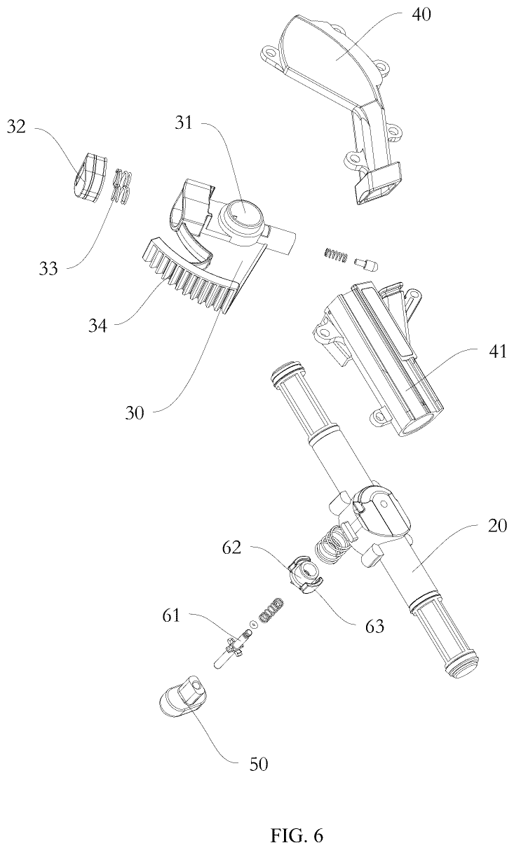

### DETAILED DESCRIPTION OF THE EMBODIMENTS

In order to make the objectives, technical solutions, and advantages of the implementations of the present disclosure clearer, the technical solutions in the implementations of the present disclosure will be clearly and completely described below in conjunction with the accompanying drawings in the implementations of the present disclosure. Obviously, the described implementations are some, rather than all of the implementations of the present disclosure. All other implementations obtained by those of ordinary skill in the art based on the implementations of the present disclosure without creative efforts shall fall within the protection scope of the present disclosure. Therefore, the above detailed description of the implementations of the present disclosure in the accompanying drawings is not intended to limit the protection scope of the present disclosure, but merely indicates selected implementations of the present disclosure. All other implementations obtained by those of ordinary skill in the art based on the implementations of the present disclosure without creative efforts shall fall within the protection scope of the present disclosure.

It should be understood that, in the description of the present disclosure, the terms such as “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “anticlockwise” are intended to indicate orientations shown in the drawings. It should be noted that these terms are merely intended to facilitate a simple description of the present disclosure, rather than to indicate or imply that the mentioned apparatus or elements must have the specific orientation or be constructed and operated in the specific orientation. Therefore, these terms may not be construed as a limitation to the present disclosure.

In addition, the terms such as “first” and “second” are used only for descriptive purposes, and should not be construed as indicating or implying relative importance or implying the number of indicated technical features. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified, the terms “installation”, “interconnection”, “connection” and “fixation” are intended to be understood in a broad sense. For example, the connection may be a fixed connection, removable connection or integral connection; may be a mechanical connection or electrical connection; may be a direct connection or indirect connection using a medium; and may be a communication or interaction between two elements. Those of ordinary skill in the art may understand the specific meanings of the above terms in the present disclosure based on specific situations.

In the present disclosure, unless otherwise expressly specified and defined, that a first feature is “above” or “under” a second feature may include that the first feature is in direct contact with the second feature, or that the first feature and the second feature are not in direct contact with each other but are in contact by using another feature between them. In addition, that the first feature is “over”, “above”, and “on” the second feature includes that the first feature is directly above and diagonally above the second feature, or simply indicates that a horizontal height of the first feature is larger than that of the second feature. That the first feature is “under” and “below” the second feature includes that the first feature is directly under or obliquely under the second feature, or simply indicates that the horizontal height of the first feature is lower than that of the second feature.

Referring to the figures in the description, a push-button shower head configured to be paused at any time includes body 10. The body may include components such as a water outlet panel. Movable core shaft 20 is provided in the body. The core shaft may move along an axial direction. Water passing channel 21 is formed in the core shaft. The water passing channel provides a channel for entering water. A pause mechanism configured to control whether to allow water to pass through the water passing channel is provided on the core shaft. The pause mechanism is mainly intended to realize whether the water can flow to a next position through the core shaft. The pause mechanism mainly uses the existing ball-point pen structure, which is not described in detail herein. The body is further provided with at least two water outlet channels 11. Each of the water outlet channels may correspond to one spray mode. In this way, water flows from different water outlet channels have different spray effects, thereby achieving the better functional effect of the spray head. A water distribution mechanism is further provided in the body. A water inlet end of the water distribution mechanism is configured to communicate with the water passing channel, and a water outlet end of the water distribution mechanism is configured to communicate with the water outlet channel. The water distribution mechanism is mainly configured to allow a water flow of the core shaft to flow to different water channels, and is controlled by a push button. The push button may be cooperatively connected to an operating end of the water distribution mechanism, and an operating end of the pause mechanism, thereby directly or indirectly controlling the water distribution mechanism and the pause mechanism.

Preferably, the water distribution mechanism includes water distributor 30 configured to rotate relative to the body. The water distributor is connected to the annularly provided water outlet channel through rotation, thereby realizing a water distribution function. A water outlet end of the water distributor can communicate with the water outlet channel. The water distributor rotates a certain angle relative to the body, such that the water distributor can communicate with the other water outlet channel from one water outlet channel. Further, water inlet cavity 31 is formed in the water distributor. Cup seal 32 and spring 33 cooperating with each other are provided between the water outlet end of the water distributor and a water inlet end of the water outlet channel. Through rotation of the water distributor, the water distributor can communicate with different water outlet channels. This can ensure the overall sealing effect, and prevent the water flow from leaking between the water distributor and the water outlet channel.

Further, the push-button shower head configured to be paused at any time further includes water inlet body 40. A water inlet end of the water inlet body is configured to communicate with the water passing channel, and a water outlet end of the water inlet body is configured to communicate with the water inlet cavity. The water distributor can rotate relative to the water inlet cavity. The water inlet body can be fixed on the body. In an embodiment, the water inlet body and the water inlet cavity of the water distributor are connected in a circular snap-fit relationship, such that a water flow of the water inlet body can directly flow to the water inlet cavity, and flow to the water outlet channel at last.

In use, the push-button shower head configured to be paused at any time further includes adapter 41 connected to the water inlet body. The core shaft can be sleeved in the adapter. In other words, a water outlet end of the core shaft is inserted into the adapter. The core shaft can move relative to the adapter. A water outlet end of the water passing channel can communicate with the adapter. Branched water channel 42 is further provided on the adapter. In an embodiment, the adapter may be similar to a Y shape. A water inlet end of the branched water channel is configured to communicate with the water passing channel, and a water outlet end of the branched water channel is configured to communicate with the water inlet cavity through the water inlet body.

Preferably, the core shaft is further connected to push rod 22. The push rod can move synchronously with the core shaft. Rack 23 is provided on the push rod. Connecting gear 34 is provided on a circumferential sidewall of the water distributor. The rack can be cooperatively connected to the connecting gear. The core shaft moves to drive the water distributor to rotate relative to the body. When the core shaft moves, the water distributor is driven to rotate through a gear-rack principle, such that the water distributor communicates with different water outlet channels to switch the water flow.

Further, the push-button shower head configured to be paused at any time further includes push button 50. The push button can be connected to central shaft 61 of the pause mechanism. The push button can be configured to push the core shaft to move relative to the body. The push button is configured to drive the pause mechanism to control whether to allow water to pass through the water passing channel. The pause mechanism includes rotatable rotor 62. The rotor is provided in water passing cavity 24 in the water passing channel. Baffle 63 is provided on a sidewall of the rotor. The baffle can be cooperatively connected to an inlet and/or outlet 25 of the water passing cavity.

Specifically, guide strip 70 is further provided on the body, and the guide strip can cooperate with the push rod to play a guiding role.

In the present disclosure, in order to solve the existing problem, the water distribution mechanism and the pause mechanism are connected by the push button. The pause mechanism is provided on the water passing channel of the core shaft. While switching the water distribution mechanism for water distribution, the push button can press the pause mechanism, such that the water passing channel is paused. In this way, the present disclosure can be paused at any time for each spray, facilitates the user, and is unnecessarily switched repeatedly to find the pause gear. For the switched water distribution mechanism, the water distribution mechanism is provided at a rear end of the core shaft. The push rod and the rack are used to drive the water distributor having the gear to rotate, thereby driving the cup seal to rotate to correspond to different water outlet channels. For the pause mechanism, the pause mechanism moves synchronously with the core shaft. The pause mechanism can be paused at any time. The pause mechanism uses the switching principle of the ball-point pen, and rotates through the rotor to obstruct the water.

The preferred embodiments of the present disclosure are described above. But as mentioned above, it should be understood that the present disclosure is not limited to the form disclosed herein, and should not be regarded as an exclusion of other embodiments. The present disclosure also apply to various combinations, modifications and scenarios in other form, and changes can be made through the above guides and technologies or knowledge in the related fields within the scope of conception of the present disclosure described herein. Changes and variations made by those skilled in the art without departing from the spirit and scope of the present disclosure should fall within the protection scope of the appended claims of the present disclosure.

1. A push-button shower head configured to be paused at any time, comprising a body, wherein a movable core shaft is provided in the body; a water passing channel is formed in the movable core shaft; a pause mechanism configured to control whether to allow water to pass through the water passing channel is provided on the movable core shaft; the body is further provided with at least two water outlet channels; a water distribution mechanism is provided in the body; and a water inlet end of the water distribution mechanism is configured to communicate with the water passing channel, and a water outlet end of the water distribution mechanism is configured to communicate with each of the at least two water outlet channels.

2. The push-button shower head according to claim 1, wherein the water distribution mechanism comprises a water distributor configured to rotate relative to the body; and a water outlet end of the water distributor communicates with each of the at least two water outlet channels.

3. The push-button shower head according to claim 2, wherein a water inlet cavity is formed in the water distributor; a cup seal and a spring cooperating with each other are provided between the water outlet end of the water distributor and a water inlet end of each of the at least two water outlet channels; and through rotation of the water distributor, the water distributor communicates with the at least two water outlet channels.

4. The push-button shower head according to claim 3, further comprising a water inlet body, wherein a water inlet end of the water inlet body is configured to communicate with the water passing channel, and a water outlet end of the water inlet body is configured to communicate with the water inlet cavity; the water distributor rotates relative to the water inlet cavity; and the water inlet body is fixed on the body.

5. The push-button shower head according to claim 4, further comprising an adapter connected to the water inlet body, wherein the movable core shaft is sleeved in the adapter; a water outlet end of the water passing channel communicates with the adapter; a branched water channel is provided on the adapter; and a water inlet end of the branched water channel is configured to communicate with the water passing channel, and a water outlet end of the branched water channel is configured to communicate with the water inlet cavity through the water inlet body.

6. The push-button shower head according to claim 2, wherein the movable core shaft is further connected to a push rod; the push rod moves synchronously with the movable core shaft; a rack is provided on the push rod; a connecting gear is provided on a circumferential sidewall of the water distributor; the rack is cooperatively connected to the connecting gear; and the movable core shaft moves to drive the water distributor to rotate relative to the body.

7. The push-button shower head according to claim 6, further comprising a push button, wherein the push button is connected to a central shaft of the pause mechanism; the push button is configured to push the movable core shaft to move relative to the body; and the push button is configured to drive the pause mechanism to control whether to allow water to pass through the water passing channel.

8. The push-button shower head according to claim 7, wherein the pause mechanism comprises a rotatable rotor; the rotatable rotor is provided in a water passing cavity in the water passing channel; a baffle is provided on a sidewall of the rotatable rotor; and the baffle is cooperatively connected to an inlet and/or an outlet of the water passing cavity.

9. The push-button shower head according to claim 8, wherein a guide strip is provided on the body, and the guide strip cooperates with the push rod.

10. The push-button shower head according to claim 3, wherein the movable core shaft is further connected to a push rod; the push rod moves synchronously with the movable core shaft; a rack is provided on the push rod; a connecting gear is provided on a circumferential sidewall of the water distributor; the rack is cooperatively connected to the connecting gear; and the movable core shaft moves to drive the water distributor to rotate relative to the body.

11. The push-button shower head according to claim 4, wherein the movable core shaft is further connected to a push rod; the push rod moves synchronously with the movable core shaft; a rack is provided on the push rod; a connecting gear is provided on a circumferential sidewall of the water distributor; the rack is cooperatively connected to the connecting gear; and the movable core shaft moves to drive the water distributor to rotate relative to the body.

12. The push-button shower head according to claim 5, wherein the movable core shaft is further connected to a push rod; the push rod moves synchronously with the movable core shaft; a rack is provided on the push rod; a connecting gear is provided on a circumferential sidewall of the water distributor; the rack is cooperatively connected to the connecting gear; and the movable core shaft moves to drive the water distributor to rotate relative to the body.

13. The push-button shower head according to claim 10, further comprising a push button, wherein the push button is connected to a central shaft of the pause mechanism; the push button is configured to push the movable core shaft to move relative to the body; and the push button is configured to drive the pause mechanism to control whether to allow water to pass through the water passing channel.

14. The push-button shower head according to claim 13, wherein the pause mechanism comprises a rotatable rotor; the rotatable rotor is provided in a water passing cavity in the water passing channel; a baffle is provided on a sidewall of the rotatable rotor; and the baffle is cooperatively connected to an inlet and/or an outlet of the water passing cavity.

15. The push-button shower head according to claim 14, wherein a guide strip is provided on the body, and the guide strip cooperates with the push rod.

16. The push-button shower head according to claim 11, further comprising a push button, wherein the push button is connected to a central shaft of the pause mechanism; the push button is configured to push the movable core shaft to move relative to the body; and the push button is configured to drive the pause mechanism to control whether to allow water to pass through the water passing channel.

17. The push-button shower head according to claim 16, wherein the pause mechanism comprises a rotatable rotor; the rotatable rotor is provided in a water passing cavity in the water passing channel; a baffle is provided on a sidewall of the rotatable rotor; and the baffle is cooperatively connected to an inlet and/or an outlet of the water passing cavity.

18. The push-button shower head according to claim 17, wherein a guide strip is provided on the body, and the guide strip cooperates with the push rod.

19. The push-button shower head according to claim 12, further comprising a push button, wherein the push button is connected to a central shaft of the pause mechanism; the push button is configured to push the movable core shaft to move relative to the body; and the push button is configured to drive the pause mechanism to control whether to allow water to pass through the water passing channel.

20. The push-button shower head according to claim 19, wherein the pause mechanism comprises a rotatable rotor, the rotatable rotor is provided in a water passing cavity in the water passing channel; a baffle is provided on a sidewall of the rotatable rotor, and the baffle is cooperatively connected to an inlet and/or an outlet of the water passing cavity.
